(19) United States
(12) Patent Application Publication
(10) Pub. No.: US 2021/0109515 A1
(43) Pub. Date: Apr. 15, 2021

(54) REMOTE AUTONOMOUS DRIVING VEHICLE AND VEHICLE REMOTE INSTRUCTION SYSTEM

(71) Applicant: Toyota Jidosha Kabushiki Kaisha, Toyota-shi Aichi-ken (JP)

(72) Inventors: Hiromitsu Urano, Numazu-shi (JP); Sho Otaki, Yokohama-shi (JP); Takayuki Iwamoto, Sunto-gun (JP)

(21) Appl. No.: 17/065,669

(22) Filed: Oct. 8, 2020

(30) Foreign Application Priority Data
Oct. 11, 2019 (JP) 2019-187894

(51) Int. Cl. G05D 1/00; B60W 60/00; G05D 1/02

(52) U.S. Cl. CPC G05D 1/0022; B60W 60/001; G05D 1/0246; G05D 2201/0213; B60W 2556/45; B60W 2420/42; G05D 1/0027

(57) ABSTRACT

A remote autonomous driving vehicle transmits sensor information detected by a sensor to a remote instruction apparatus, and travels based on a remote instruction from a remote commander. The remote autonomous driving vehicle includes a sensor type determination unit configured to determine a type of the sensor that transmits the sensor information to the remote instruction apparatus based on an external environment and map information; and a sensor information transmission unit configured to transmit the sensor information detected by the sensor of which the type is determined by the sensor type determination unit to the remote instruction apparatus.

### CROSS-REFERENCE TO RELATED APPLICATION

This application claims the benefit of priority from Japanese Patent Application No. 2019-187894, filed on Oct. 11, 2019, the entire contents of which are incorporated herein by reference.

### TECHNICAL FIELD

The present disclosure relates to a remote autonomous driving vehicle that travels based on a remote instruction from a remote commander, and a remote instruction system.

### BACKGROUND

For example, Japanese Unexamined Patent Publication No. 2018-180771 discloses a remote autonomous driving vehicle that transmits sensor information from a remote autonomous driving vehicle to a remote instruction apparatus, and travels based on a remote instruction issued from a remote commander through the remote instruction apparatus.

This remote autonomous driving vehicle includes a plurality of sensors, and as a vehicle speed increases, a data amount of the sensor information transmitted to the remote instruction apparatus increases.

If the remote instruction apparatus cannot receive the transmitted sensor information (if a communication delay occurs), the vehicle speed of the remote autonomous driving vehicle decreases.

### SUMMARY

Here, for example, in the remote autonomous driving vehicle including a plurality of sensors, the sensor information itself of a specific sensor among the plurality of sensors may not be necessary when issuing the remote instruction. If the unnecessary sensor information is transmitted to the remote commander, the transmitted data amount increases and it takes time to transmit the data, which may cause a problem that the remote commander cannot perform an appropriate determination. Therefore, in this technical field, it is required to reduce the data amount of the sensor information transmitted to the remote instruction apparatus from the remote autonomous driving vehicle, while providing the remote commander with the sensor information by an appropriate type of sensor for performing the determination of the remote instruction.

According to an aspect of the present disclosure, a remote autonomous driving vehicle includes a plurality of sensors for detecting surroundings of a vehicle, transmits sensor information detected by the sensor to a remote instruction apparatus, and travels based on a remote instruction issued from a remote commander through the remote instruction apparatus. The vehicle includes: a sensor type determination unit configured to determine a type of the sensor that transmits the sensor information to the remote instruction apparatus based on an external environment and map information; and a sensor information transmission unit configured to transmit the sensor information detected by the sensor of which the type is determined by the sensor type determination unit to the remote instruction apparatus.

According to the remote autonomous driving vehicle, the type of the sensor that transmits the sensor information to the remote instruction apparatus is determined based on the external environment or the map information, and the sensor information detected by the determined type sensor is transmitted. That is, in the remote autonomous driving vehicle, the sensor information by the sensor of which the type is determined based on the external environment or the map information is transmitted, and the sensor information by the sensor of other types is not transmitted. In this way, the remote commander can appropriately issue the remote instruction to the remote autonomous driving vehicle based on the sensor information by the sensor of which the type is determined based on the external environment or the map information. As described above, in the vehicle remote instruction system, it is possible to reduce the data amount of the sensor information transmitted from the remote autonomous driving vehicle to the remote instruction apparatus while providing the remote commander with the sensor information by the appropriate type of sensor for performing the determination of the remote instruction.

The remote autonomous driving vehicle may further include: a data amount reduction unit configured to reduce a data amount of the sensor information detected by the sensor of which the type is determined by the sensor type determination unit. The data amount reduction unit may be configured to reduce the data amount if the data amount of the sensor information detected by the sensor of which the type is determined by the sensor type determination unit is equal to or larger than a data amount threshold value determined in advance. The sensor information transmission unit may be configured to transmit the sensor information in which the data amount is reduced by the data amount reduction unit, to the remote instruction apparatus.

In this case, if the data amount of the detected sensor information is equal to or larger than the data amount threshold value, the remote autonomous driving vehicle can transmit the sensor information with reducing the data amount. In this way, the remote autonomous driving vehicle can further reduce the data amount to be transmitted to the remote instruction apparatus.

In the remote autonomous driving vehicle, the data amount reduction unit may be configured to reduce the data amount of the sensor information by limiting an angle of view to be transmitted to the remote instruction apparatus in the sensor information detected by the sensor of which the type is determined by the sensor type determination unit based on the map information.

In this case, the remote autonomous driving vehicle can further reduce the data amount of the sensor information transmitted to the remote instruction apparatus while enabling the remote commander to issue an appropriate remote instruction based on the sensor information having a limited angle of view based on the map information.

A vehicle remote instruction system according to the present disclosure includes: the remote autonomous driving vehicle described above; and a remote instruction apparatus in which a remote commander issues a remote instruction relating to travel of the remote autonomous driving vehicle.

According to the vehicle remote instruction system, the type of the sensor that transmits the sensor information to the remote instruction apparatus is determined based on the external environment or the map information, and the sensor information detected by the determined type of sensor is transmitted to the remote instruction apparatus. That is, in the vehicle remote instruction system, the sensor information by the sensor of which the type is determined based on the external environment or the map information is transmitted to the remote instruction apparatus, and the sensor information by the sensor of other types is not transmitted. In addition, in this vehicle remote instruction system, when determining the type of the sensor, the determination is performed based on the external environment or the map information. In this way, the remote commander can appropriately issue the remote instruction to the remote autonomous driving vehicle based on the sensor information by the sensor of which the type is determined based on the external environment or the map information. As described above, in the vehicle remote instruction system, it is possible to reduce the data amount of the sensor information transmitted to the remote instruction apparatus from the remote autonomous driving vehicle, while providing the remote commander with the sensor information by the appropriate type of sensor for performing the determination of the remote instruction.

According to the present disclosure, it is possible to reduce the data amount of the sensor information transmitted to the remote instruction apparatus from the remote autonomous driving vehicle, while providing the remote commander with the sensor information by the appropriate type sensor for performing the determination of the remote instruction.

### BRIEF DESCRIPTION OF THE DRAWINGS

FIG. 1 is a diagram illustrating an example of an overall image of a vehicle remote instruction system according to an embodiment.

FIG. 2 is a block diagram illustrating an example of a configuration of an autonomous driving vehicle.

FIG. 3 is a block diagram illustrating a sensor included in the external sensor.

FIG. 4 is a schematic diagram illustrating a situation in which the autonomous driving vehicle turns right at an intersection.

FIG. 5 is a block diagram illustrating an example of a hardware configuration of the remote instruction server.

FIG. 6 is a block diagram illustrating an example of the configuration of a remote instruction apparatus.

FIG. 7 is a flowchart illustrating a flow of processing by the autonomous driving ECU for generating and transmitting the travel situation information.

### DETAILED DESCRIPTION

Hereinafter, embodiments of the present disclosure will be described with reference to the drawings. In the following description, the same reference symbols will be given to the same or corresponding elements and the descriptions thereof will not be repeated.

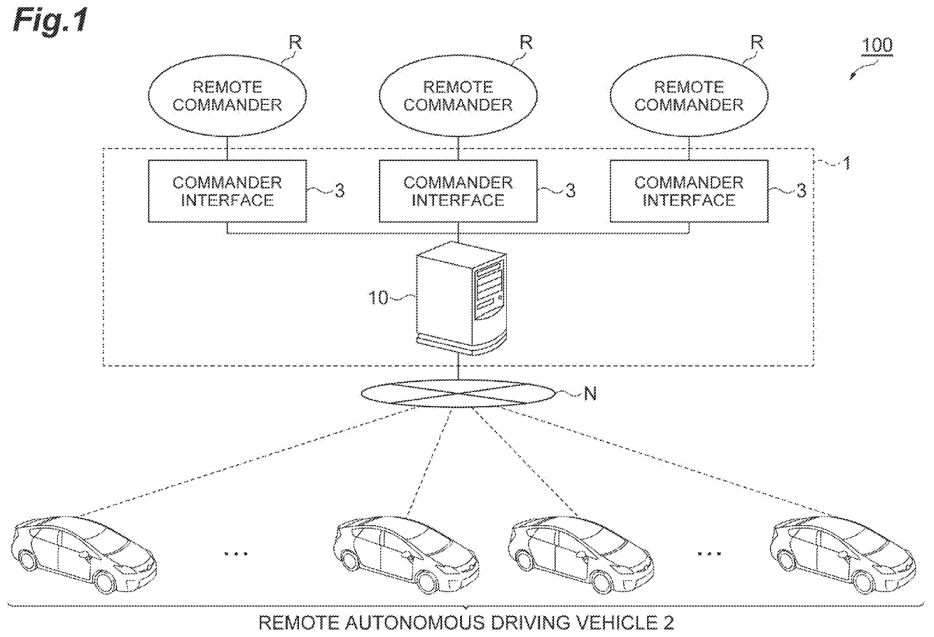

FIG. 1 is a diagram illustrating an example of an overall image of a vehicle remote instruction system according to an embodiment. A vehicle remote instruction system 100 illustrated in FIG. 1 is a system in which a remote commander R issues a remote instruction relating to travel of a remote autonomous driving vehicle 2 based on detection information by an external sensor 22 that detects an external environment of the remote autonomous driving vehicle 2. The remote instruction is an instruction from the remote commander R relating to the travel of the remote autonomous driving vehicle 2.

The remote instruction includes an instruction for the remote autonomous driving vehicle 2 to progress and an instruction for the remote autonomous driving vehicle 2 to stop. The remote instruction may include an instruction for the remote autonomous driving vehicle 2 to change the lane. In addition, the remote instruction may include an instruction to perform an offset avoidance on an obstacle ahead, an instruction to overtake a preceding vehicle, an instruction to perform an emergency evacuation, and the like.

### Configuration of Vehicle Remote Instruction System

As illustrated in FIG. 1, a vehicle remote instruction system 100 includes a remote instruction apparatus 1 to which a remote commander R inputs a remote instruction. The remote instruction apparatus 1 is communicably connected to a plurality of remote autonomous driving vehicles 2 via a network N. The network N is a wireless communication network. Various kinds of information are sent to the remote instruction apparatus 1 from the remote autonomous driving vehicle 2.

In the vehicle remote instruction system 100, for example, in response to a remote instruction request from the remote autonomous driving vehicle 2, the remote commander R is requested to input the remote instruction. The remote commander R inputs the remote instruction to the commander interface 3 of the remote instruction apparatus 1. The remote instruction apparatus 1 transmits the remote instruction to the remote autonomous driving vehicle 2 through the network N. The remote autonomous driving vehicle 2 autonomously travels according to the remote instruction.

In the vehicle remote instruction system 100, the number of remote commanders R may be one, or two or more. The number of the remote autonomous driving vehicles 2 that can communicate with the vehicle remote instruction system 100 is not particularly limited. A plurality of remote commanders R may alternately issue the remote instruction for one remote autonomous driving vehicle 2, or one remote commander R may issue the remote instruction for equal to or more than two remote autonomous driving vehicles 2.

### Configuration of Autonomous Driving Vehicle

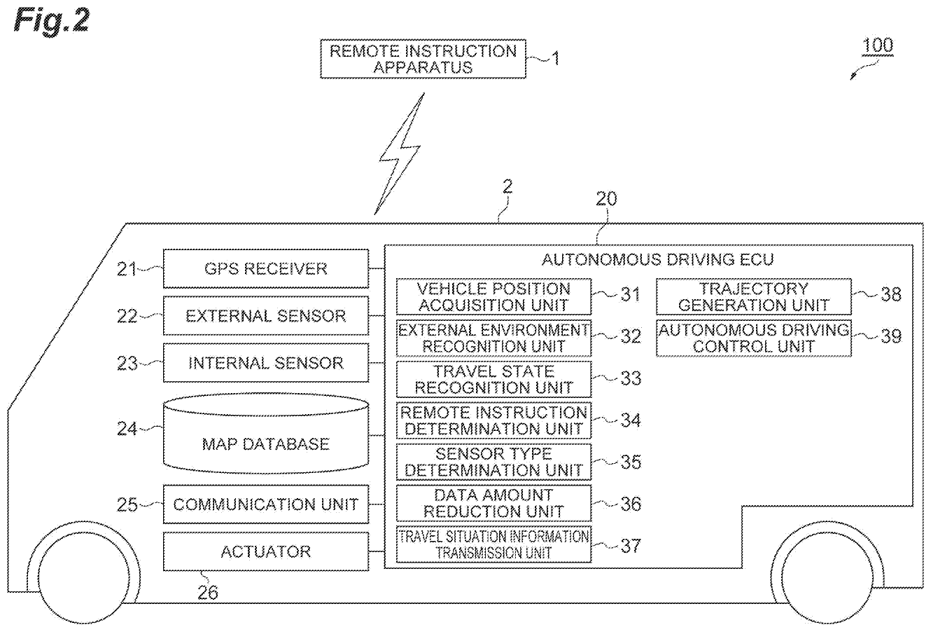

First, an example of a configuration of the remote autonomous driving vehicle 2 will be described. FIG. 2 is a block diagram illustrating an example of the configuration of the remote autonomous driving vehicle 2. As illustrated in FIG. 2, the remote autonomous driving vehicle 2 includes an autonomous driving ECU 20 as an example. The autonomous driving ECU 20 is an electronic control unit including a central processing unit (CPU), a read only memory (ROM), a random access memory (RAM), and the like. In the autonomous driving ECU 20, for example, a program recorded in the ROM is loaded into the RAM, and various functions are realized by executing the program loaded into the RAM by the CPU. The autonomous driving ECU 20 may be configured with a plurality of electronic units.

The autonomous driving ECU 20 is connected to a global positioning system (GPS) receiver 21, an external sensor 22, an internal sensor 23, a map database 24, a communication unit 25, and an actuator 26.

The GPS receiver 21 measures a position of the remote autonomous driving vehicle 2 (for example, latitude and longitude of the remote autonomous driving vehicle 2) by receiving signals from equal to or more than three GPS satellites. The GPS receiver 21 transmits the position information on the remote autonomous driving vehicle 2 to the autonomous driving ECU 20.

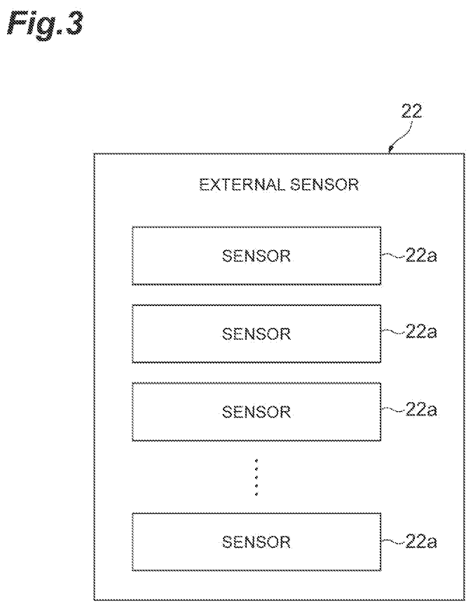

The external sensor 22 is a vehicle-mounted sensor that detects an external environment around the remote autonomous driving vehicle 2. The external sensor 22 transmits the detected detection information (sensor information) to the autonomous driving ECU 20. As illustrated in FIG. 3, the external sensor 22 includes a plurality of sensors 22a that detect the external environments.

Specifically, the external sensor 22 includes at least a camera as the sensor 22a. The camera is an imaging device that captures an image of the external environment of the remote autonomous driving vehicle 2. The camera is provided on the inside of a windshield of the remote autonomous driving vehicle 2 and images the front direction of the vehicle. The camera transmits the image information (sensor information) relating to the external environment of the remote autonomous driving vehicle 2 to the autonomous driving ECU 20. The camera may be a monocular camera or may be a stereo camera. In addition, the camera may be a camera using visible light or may be an infrared camera. In addition, a plurality of cameras may be provided, and may image all or a part of the surroundings such as the left and right side directions and the rear direction of the remote autonomous driving vehicle 2, in addition to the front direction of the remote autonomous driving vehicle 2.

The external sensor 22 may include a radar sensor as a sensor 22a. The radar sensor is a detection device that detects an object around the remote autonomous driving vehicle 2 using radio waves (for example, millimeter waves) or light. The radar sensor includes, for example, millimeter wave radar or a light detection and ranging (LIDAR). The radar sensor transmits the radio wave or light to the surroundings of the remote autonomous driving vehicle 2, and detects the objects by receiving the radio waves or the light reflected from the objects. The radar sensor transmits the detected object information (sensor information) to the autonomous driving ECU 20. The objects include fixed objects such as guardrails and buildings, and moving objects such as pedestrians, bicycles, other vehicles, and the like. A plurality of radar sensors are provided, and all or at least a part of the surroundings of the remote autonomous driving vehicle 2 is to be detected.

The external sensor 22 may include a plurality of sensors of which the detection set values are different from each other, as the sensor 22a. The detection set value is various set values set when the sensor performs the detection. For example, the external sensor 22 may include a plurality of cameras of which the detection set values are different from each other. The detection set values of the camera may be, for example, at least one of ISO sensitivity, an F-value, and an exposure time. In addition, the external sensor 22 may include a sensor capable of changing the detection set values, as the sensor 22a. For example, the external sensor 22 may include a camera of which the detection set value can be changed.

As described above, the external sensor 22 includes a plurality of different types of sensors 22a. The difference in the types of the sensor 22a in the present embodiment is assumed to mean that the sensors are having different types of detection method (types of detection), such as the camera and the LIDAR. Furthermore, the difference in the types of the sensor 22a in the present embodiment is assumed to mean that the detection method itself is the same or similar, but the configuration such as the wavelength used is partially different, such as the camera using the visible light and the infrared camera. Furthermore, the difference in the types of the sensor 22a in the present embodiment is assumed to mean that, for example, the detection method itself is the same, but the sensors are having different detection set values, such as the cameras having different detection set values such as the ISO sensitivity or the like. In addition, the difference in the types of the sensor 22a in this embodiment is assumed to mean that the sensors are having different types of obtained data, such as image data and point cloud data. Furthermore, the difference in the types of the sensor 22a in this embodiment is assumed to mean that, for example, the sensors are having different image qualities.

The internal sensor 23 is a vehicle-mounted sensor that detects a travel state of the remote autonomous driving vehicle 2. The internal sensor 23 includes a vehicle speed sensor, an acceleration sensor, and a yaw rate sensor. The vehicle speed sensor is a measurement device that measures a speed of the remote autonomous driving vehicle 2. As the vehicle speed sensor, for example, a vehicle wheel speed sensor is used, which is provided on vehicle wheels of the remote autonomous driving vehicle 2 or on a drive shaft rotating integrally with vehicle wheels, and measures a rotational speed of the vehicle wheels. The vehicle speed sensor transmits the measured vehicle speed information (vehicle wheel speed information) to the autonomous driving ECU 20.

The acceleration sensor is a measurement device that measures an acceleration of the remote autonomous driving vehicle 2. The acceleration sensor includes, for example, a longitudinal acceleration sensor that measures acceleration in the longitudinal direction of the remote autonomous driving vehicle 2 and the acceleration sensor may include a lateral acceleration sensor that measures a lateral acceleration of the remote autonomous driving vehicle 2. The acceleration sensor transmits, for example, acceleration information on the remote autonomous driving vehicle 2 to the autonomous driving ECU 20. The yaw rate sensor is a measurement device that measures a yaw rate (rotation angular velocity) around the vertical axis at the center of gravity of the remote autonomous driving vehicle 2. As the yaw rate sensor, for example, a Gyro sensor can be used. The yaw rate sensor transmits the measured yaw rate information on the remote autonomous driving vehicle 2 to the autonomous driving ECU 20.

The map database 24 is a database that records map information. The map database 24 is formed, for example, in a recording device such as a hard disk drive (HDD) mounted on the remote autonomous driving vehicle 2. The map information includes information on the position of the road, information on the shape of the road (for example, curvature information) and position information on the intersection and the branch. The map information may include traffic regulation information such as a legal speed associated with the position information. The map information may include target object information used for acquiring the position information on the remote autonomous driving vehicle 2. As the target object, road signs, road markings, traffic signals, utility poles, and the like can be used. The map database 24 may be configured as a server that can communicate with the remote autonomous driving vehicle 2.

The communication unit 25 is a communication device that controls the wireless communication with the outside of the remote autonomous driving vehicle 2. The communication unit 25 transmits and receives various information to and from the remote instruction apparatus 1 (the remote instruction server 10) via the network N.

The actuator 26 is a device used for controlling the remote autonomous driving vehicle 2. The actuator 26 includes at least a drive actuator, a brake actuator, and a steering actuator. The drive actuator controls a driving force of the remote autonomous driving vehicle 2 by controlling an amount of air (throttle opening degree) supplied to the engine according to a control signal from the autonomous driving ECU 20. If the remote autonomous driving vehicle 2 is a hybrid vehicle, in addition to the amount of air supplied to the engine, the control signal from the autonomous driving ECU 20 is input to a motor as a power source, and then, the driving force is controlled. If the remote autonomous driving vehicle 2 is an electric vehicle, the control signal from the autonomous driving ECU 20 is input to a motor as a power source, and then, the driving force is controlled. The motor as the power source in these cases configures the vehicle actuator 26.

The brake actuator controls a brake system according to a control signal from the autonomous driving ECU 20 and controls a braking force applied to the vehicle wheels of the remote autonomous driving vehicle 2. For example, a hydraulic brake system can be used as the brake system. The steering actuator controls the driving of an assist motor controlling a steering torque of an electric power steering system according to a control signal from the autonomous driving ECU 20. In this way, the steering actuator controls the steering torque of the remote autonomous driving vehicle 2.

Next, an example of a functional configuration of the autonomous driving ECU 20 will be described. The autonomous driving ECU 20 includes a vehicle position acquisition unit 31, an external environment recognition unit 32, a travel state recognition unit 33, a remote instruction determination unit 34, a sensor type determination unit 35, a data amount reduction unit 36, a travel situation information transmission unit (sensor information transmission unit) 37, a trajectory generation unit 38, and an autonomous driving control unit 39.

The vehicle position acquisition unit 31 acquires position information (position on the map) on the remote autonomous driving vehicle 2 based on the position information from the GPS receiver 21 and the map information in the map database 24. The vehicle position acquisition unit 31 may acquire the position information on the remote autonomous driving vehicle 2 using the target object information included in the map information in the map database 24 and the result of detection performed by the external sensor 22 using the simultaneous localization and mapping (SLAM) technology. The vehicle position acquisition unit 31 may recognize a lateral position of the remote autonomous driving vehicle 2 relative to a lane (the position of the remote autonomous driving vehicle 2 in the lane width direction) from a positional relationship between lane marking lines and the remote autonomous driving vehicle 2, and then, may include the lateral position in the position information. The vehicle position acquisition unit 31 may acquire the position information on the remote autonomous driving vehicle 2 using another known method.

The external environment recognition unit 32 recognizes the external environment of the remote autonomous driving vehicle 2 based on the result of detection performed by the external sensor 22. The external environment includes a relative position of surrounding objects relative to the remote autonomous driving vehicle 2. The external environment may include the relative speed and moving direction of the surrounding objects relative to the remote autonomous driving vehicle 2. The external environment may include types of the objects such as other vehicles, pedestrians, and bicycles. The types of the object can be identified by a known method such as pattern matching. The external environment may include a result of recognition of the marking lines (lane line recognition) around the remote autonomous driving vehicle 2. The external environment may include a result of recognition of a lighting state of a traffic signal. The external environment recognition unit 32 can recognize the lighting state of the traffic signal (the lighting state in which the vehicle can pass or the lighting state in which the vehicle is not allowed to pass) in the front direction of the remote autonomous driving vehicle 2 based on, for example, the image from the camera of the external sensor 22.

The external environment recognition unit 32 recognizes a weather around the remote autonomous driving vehicle 2 as the external environment of the remote autonomous driving vehicle 2. For example, the external environment recognition unit 32 can recognize whether or not the remote autonomous driving vehicle 2 is traveling in an area where it rains or an area where fog occurs. For example, if the external sensor 22 includes a rain sensor, the external environment recognition unit 32 may recognize whether or not the remote autonomous driving vehicle 2 is traveling in an area where it rains based on the result of detection performed by the rain sensor. In addition, the external environment recognition unit 32 may acquire the information on the weather in the area where the remote autonomous driving vehicle 2 is traveling, from an external weather information center or the like, and then, may recognize whether it rains or the fog occurs based on the acquired information. As described above, the external environment recognition unit 32 can recognize the weather around the remote autonomous driving vehicle 2 using various known methods.

The external environment recognition unit 32 recognizes the brightness around the remote autonomous driving vehicle 2 as the external environment of the remote autonomous driving vehicle 2. For example, if the external sensor 22 includes an illuminance sensor, the external environment recognition unit 32 may recognize the brightness around the remote autonomous driving vehicle 2 based on the result of detection performed by the illuminance sensor. In addition, the external environment recognition unit 32 may recognize the brightness around the remote autonomous driving vehicle 2 based on the time, for example. For example, the external environment recognition unit 32 may recognize that it is dark around the vehicle when the time is night time, and recognize that it is bright around the vehicle when the time is daytime.

The external environment recognition unit 32 recognizes the temperature around the remote autonomous driving vehicle 2 as the external environment of the remote autonomous driving vehicle 2. For example, if the external sensor 22 includes a temperature sensor that detects the temperature around the remote autonomous driving vehicle 2, the external environment recognition unit 32 recognizes the temperature around the remote autonomous driving vehicle 2 based on the result of detection performed by the temperature sensor. In addition, the external environment recognition unit 32 may acquire information on the temperature at the area where the remote autonomous driving vehicle 2 is traveling, from an external weather information center or the like, and may recognize the temperature around the remote autonomous driving vehicle 2 based on the acquired information on the temperature. As described above, the external environment recognition unit 32 can recognize the temperature around the remote autonomous driving vehicle 2 using various known methods.

The travel state recognition unit 33 recognizes the travel state of the remote autonomous driving vehicle 2 based on the result of detection performed by the internal sensor 23. The travel state includes the vehicle speed of the remote autonomous driving vehicle 2, the acceleration of the remote autonomous driving vehicle 2, and the yaw rate of the remote autonomous driving vehicle 2. Specifically, the travel state recognition unit 33 recognizes the vehicle speed of the remote autonomous driving vehicle 2 based on the vehicle speed information from the vehicle speed sensor. The travel state recognition unit 33 recognizes the acceleration of the remote autonomous driving vehicle 2 based on the vehicle speed information from the acceleration sensor. The travel state recognition unit 33 recognizes the orientation of the remote autonomous driving vehicle 2 based on the yaw rate information from the yaw rate sensor.

The remote instruction determination unit 34 determines whether a remote instruction request to the remote commander R (remote instruction apparatus 1) from the remote autonomous driving vehicle 2 is required or not. The remote instruction determination unit 34 determines whether the remote instruction request is required or not based on at least one of the position information on the remote autonomous driving vehicle 2 acquired by the vehicle position acquisition unit 31 and the map information in the map database 24, the external environment recognized by the external environment recognition unit 32, and the trajectory generated by the trajectory generation unit 38 described later.

When the remote autonomous driving vehicle 2 is in a remote instruction required situation, the remote instruction determination unit 34 determines that the remote instruction request is required. The remote instruction required situation is a situation set in advance as a situation in which the remote instruction request to the remote instruction apparatus 1 from the autonomous driving vehicle is required.

The remote instruction required situation may include, for example, at least one of a situation in which the remote autonomous driving vehicle 2 is turning right or left at the intersection, a situation of entering the intersection with or without a traffic signal, a situation of entering the roundabout, a situation of passing through the pedestrian crossing, a situation in which a stopped vehicle or an obstacle is present ahead, a situation of changing the lane to avoid the construction site, a situation in which a determination of offset avoidance for the obstacles ahead is required, a situation in which the stopped autonomous driving vehicle starts, and a situation in which the autonomous driving vehicle stops at a boarding location or a destination. In a case of a country or a region of a vehicle's right-side traffic, a situation of turning right at the intersection may be replaced by a situation of turning left at the intersection.

For example, if the remote autonomous driving vehicle 2 is in a situation of entering the intersection or turning right at the intersection, the remote instruction determination unit 34 determines that the remote instruction request is required. The remote instruction determination unit 34 may determine that the remote instruction request is required if an obstacle for which the offset avoidance is required is present in the front direction of the remote autonomous driving vehicle 2.

The remote instruction determination unit 34 can recognize that the remote autonomous driving vehicle 2 is in the situation of turning right at the intersection, the remote autonomous driving vehicle 2 is in the situation of approaching the intersection with a traffic signal, or the remote autonomous driving vehicle 2 is in the situation of starting the lane change, from the position information, the map information, and the target route of the remote autonomous driving vehicle 2, for example.

If it is determined that the remote instruction request is required, the remote instruction determination unit 34 requests the remote instruction server 10 for the remote instruction by the remote commander R. The remote instruction request includes, for example, identification information on the remote autonomous driving vehicle 2. The remote instruction determination unit 34 may request for the remote instruction with a margin time in advance. When a distance between the intersection or the like subject to the remote instruction and the remote autonomous driving vehicle 2 is equal to or shorter than a certain distance, the remote instruction determination unit 34 may determine that the remote instruction request is required. The remaining time for arrival may be used instead of the distance.

If the remote instruction determination unit 34 determines that the remote instruction request is required, the sensor type determination unit 35 determines the type of the sensor 22a that transmits the sensor information to the remote instruction apparatus 1, based on the external environment of the remote autonomous driving vehicle 2 or the map information. For example, the sensor type determination unit 35 may determine the type of the sensor 22a that can detect appropriate information when the remote commander R issues the remote instruction as the type of the sensor 22a, based on the external environment or the map information. Here, the appropriate information when the remote commander R issues the remote instruction may be information in which the remote commander R can easily recognize the situation around the remote autonomous driving vehicle 2.

Hereinafter, various specific examples of the determination of the type of the sensor 22a in the sensor type determination unit 35 will be described.

Example of Setting Type when it Rains or Fog Occurs

For example, light emitted from the LIDAR has a characteristic that it is reflected from water. Therefore, when it rains or when the fog occurs, noise may occur around the LIDAR. In addition, when the temperature around the remote autonomous driving vehicle 2 is low, the exhaust gas from the engine is condensed in the air, and the light emitted from the LIDAR is reflected from the condensed exhaust gas. This may cause the LIDAR to detect the condensed exhaust gas as if an object is present.

Therefore, for example, when it rains or the fog occurs, the sensor type determination unit 35 determines the type of the sensor 22a that transmits the sensor information to the remote instruction apparatus 1 to be a camera. Similarly, for example, if the surroundings of the remote autonomous driving vehicle 2 are in a cold temperature state, the sensor type determination unit 35 determines the type of the sensor 22a that transmits the sensor information to the remote instruction apparatus 1, as the camera. The sensor type determination unit 35 can determine whether it rains or not, whether the fog occurs or not, or whether it is in a low temperature state or not, based on the result of recognition performed by the external environment recognition unit 32.

### Example of Setting Type at Night Time

For example, a camera capturing an image using the visible light is a sensor that is effective for the remote commander R to recognize the surrounding environment of the remote autonomous driving vehicle 2. However, in some cases in a dark environment such as at the night time, the performance of the camera may not be used effectively. For example, there is a possibility that an image captured far away in the light emitting direction of the headlights of the remote autonomous driving vehicle 2 can be acquired. On the other hand, for example, for the destination area of the right turn in the scene of turning right at the intersection or for the area of the rear direction in the scene of turning left and in the scene overtaking, since the remote autonomous driving vehicle 2 does not include a light for emitting the light to those directions, there is a possibility that only a dark image (black image) can be acquired. Such a captured image is not enough for the remote commander R to perform an appropriate remote instruction determination.

Therefore, for example, in a dark environment such as at the night time, the sensor type determination unit 35 determines the type of the sensor 22a that transmits the sensor information to the remote instruction apparatus 1 to be an infrared camera or a LIDAR. The sensor type determination unit 35 can determine whether it is in a dark environment such as at the night time based on the result of recognition performed by the external environment recognition unit 32.

Example of Setting Type when Entering or Exiting Tunnel

For example, when the remote autonomous driving vehicle 2 enters or exits a tunnel, the difference in illuminance (dynamic range) in the front direction of the remote autonomous driving vehicle 2 becomes extremely large. For this reason, in the case of a camera, for example, when the remote autonomous driving vehicle 2 enters the tunnel, a portion of the image captured at just beginning of the tunnel (in the tunnel) becomes black, and the information on this portion cannot be used. Conversely, in the case of the camera, for example, when the remote autonomous driving vehicle 2 exits the tunnel, a portion of the image captured at just of the tunnel becomes white, and the information on this portion cannot be used.

In order to obtain the information from the image captured by the camera even in a dark environment, a camera with a high ISO sensitivity, a camera with a small F-value (a camera that can receive a lot of light without stopping down), or a camera with a long exposure time is effective. Conversely, a camera that is effective in a bright environment may have detection set values opposite to those described above.

Therefore, the sensor type determination unit 35 determines whether or not the remote autonomous driving vehicle 2 is in the situation of entering or exiting the tunnel. The sensor type determination unit 35 determines a camera having the appropriate detection set values (for example, the ISO sensitivity, the F value, the exposure time, or the like) according to the result of determination, as the type of the sensor 22a that transmits the sensor information to the remote instruction apparatus 1. For example, it is assumed that a plurality of cameras of which the detection set values are different from each other are provided in the external sensor 22. In this case, among the plurality of cameras having different detection set values, the sensor type determination unit 35 determines the camera having an appropriate detection set value (the ISO sensitivity, the F-value, the exposure time, or the like.) according to the result of determination, as a type of the sensor 22a that transmits the sensor information to the remote instruction apparatus 1. On the other hand, for example, it is assumed that a camera capable of changing the detection set values (for example, at least one of the ISO sensitivity, the F value, and the exposure time) is provided in the external sensor 22. In this case, the sensor type determination unit 35 can determine the camera of which the detection set value is set (switched) according to the result of determination, as the type of the sensor 22a that transmits the sensor information to the remote instruction apparatus 1.

Further, in some case as in a case where the remote autonomous driving vehicle 2 enters a tunnel, the sensor information on both the vicinity and the distant place of the remote autonomous driving vehicle 2 are required to be presented to the remote commander R. In this case, the vicinity of the remote autonomous driving vehicle 2 is a place where the illuminance is relatively high, and the distant place of the remote autonomous driving vehicle 2 is a place where the illuminance is relatively low. If the illuminance of the places from which the sensor information is to be presented are different from each other as above, the sensor type determination unit 35 may determine both the camera for the place of high illuminance (the camera capable of appropriately capturing the image even when the illuminance is high) and the camera for the place of the low illuminance (the camera capable of appropriately capturing the image even when the illuminance is low), as the type of the sensor 22a that transmits the sensor information to the remote instruction apparatus 1.

In addition, when the type of the sensor 22a is determined according to whether or not the situation is entering or exiting the tunnel, the sensor type determination unit 35 may select the LIDAR instead of the camera, as described in the above “example of setting type at night time” described above.

The sensor type determination unit 35 can determine whether or not the remote autonomous driving vehicle 2 is in a situation of entering or exiting the tunnel based on, for example, the map information in the map database 24 and the position information on the remote autonomous driving vehicle 2 recognized by the vehicle position acquisition unit 31. In addition, the sensor type determination unit 35 may use the trajectory generated by the trajectory generation unit 38 described later, in addition to the map information and the position information on the remote autonomous driving vehicle 2.

In addition, other than the case where the remote autonomous driving vehicle 2 enters and exits the tunnel described above as an example, the sensor type determination unit 35 can determine the type of the sensor 22a that transmits the sensor information to the remote instruction apparatus 1, according to the situation (environment) around the remote autonomous driving vehicle 2 obtained based on the map information.

The data amount reduction unit 36 reduces the data amount of the sensor information detected by the sensor 22a of which the type is determined by the sensor type determination unit 35. Here, if the data amount of the sensor information detected by the sensor 22a of which the type is determined by the sensor type determination unit 35 is equal to or larger than a data amount threshold value set in advance, the data amount reduction unit 36 performs the reduction of the data amount. The data amount reduction unit 36 can reduce the data amount using various methods. Hereinafter, specific examples of the data amount reduction method performed by the data amount reduction unit 36 will be described.

First Reduction Method: Reduction Method based on Angle of View

As a first reduction method of the data amount, among the sensor information detected by the sensor 22a of which the type is determined by the sensor type determination unit 35 based on the map information, the data amount reduction unit 36 limits an angle of view of the sensor information to be transmitted to the remote instruction apparatus 1. Here, as a way of limiting the angle of view of the sensor information to be transmitted, the data amount reduction unit 36 limits the detection range when the external sensor 22 performs the detection.

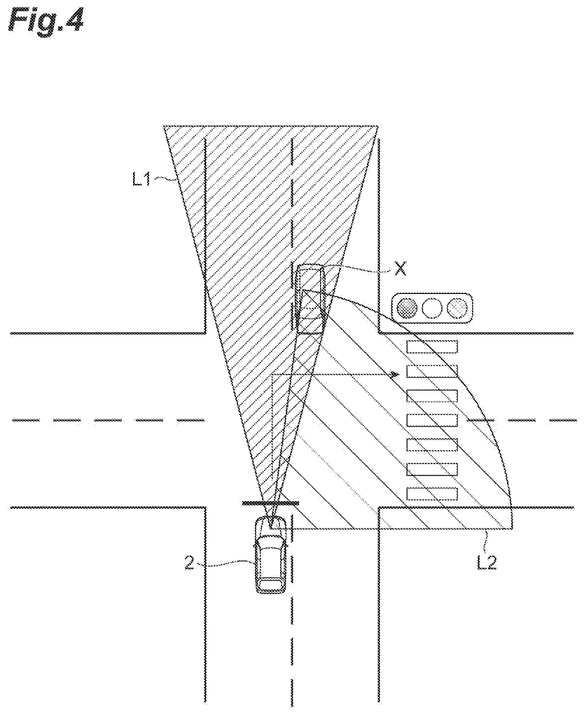

Here, for example, as illustrated in FIG. 4, in a situation in which the remote autonomous driving vehicle 2 turns right at the intersection, as an example, when issuing remote instruction, the remote commander R needs to check the absence of both a vehicle traveling straight in the oncoming lane and a pedestrian crossing the road of the destination of right turn. That is, the place required to be checked by the remote commander R to issue the remote instruction differs depending on the external situation of the remote autonomous driving vehicle 2. Therefore, among the sensor information detected by the sensor of which the type is determined by the sensor type determination unit 35, the remote autonomous driving vehicle 2 only needs to be able to transmit a portion including a place determined according to the external situation (a place required to be checked by the remote commander R), to the remote instruction apparatus 1.

As a specific example, a case where the remote autonomous driving vehicle 2 turns right at the intersection as illustrated in FIG. 4 will be described. In addition, the situation illustrated in FIG. 4 is assumed to be a rainy day or the night time. Therefore, as described above, it is assumed that the sensor type determination unit 35 determines the LIDAR as the type of sensor that transmits the sensor information to the remote instruction apparatus 1, for example. In addition, it is assumed that the external sensor 22 includes a plurality of LIDARs each having a place (direction) as the detection area around the remote autonomous driving vehicle 2 as the detection area.

In this case, the data amount reduction unit 36 determines that the remote autonomous driving vehicle 2 is a situation where the vehicle turns right at the intersection based on the map information, the position information on the remote autonomous driving vehicle 2 acquired by the vehicle position acquisition unit 31, and the trajectory. Then, the data amount reduction unit 36 selects a LIDAR having the front direction as the detection area and a LIDAR having the right front direction (oblique right front direction) from the plurality of LIDARs included in the external sensor 22. In FIG. 4, hatched areas L1 and L2 illustrated around the remote autonomous driving vehicle 2 respectively indicates the detection area (angle of view) of the LIDAR that detects the front direction of the remote autonomous driving vehicle 2 and the detection area (angle of view) of the LIDAR that detects the right front direction of the remote autonomous driving vehicle 2.

For example, if a LIDAR having both the front direction and the right front direction as the detection areas is provided, the data amount reduction unit 36 may select that LIDAR. That is, the data amount reduction unit 36 selects one or a plurality of LIDARs including the areas required to be checked by the remote commander R as the detection areas. Then, the data amount reduction unit 36 sets the sensor information detected by the selected LIDAR as the sensor information having the limited angle of view to be transmitted to the remote instruction apparatus 1.

In addition, for example, if a LIDAR having all of the left front direction, the front direction, and the right front direction as the detection areas (for example, a LIDAR having an angle of view of 180°) is provided, the data amount reduction unit 36 may extract (limit the angle of view) only the portions of the front direction and the right front direction from the sensor information detected by this LIDAR, and may use the extracted portions of the sensor information, as the sensor information having the limited angle of view to be transmitted to the remote instruction apparatus 1. That is, if a sensor having the detection area wider than the area required to be presented to the remote commander R, the data amount reduction unit 36 extracts a portion including a range required to be presented to the remote commander R from the sensor information by that sensor. Then, the data amount reduction unit 36 may use the extracted sensor information as the sensor information having the limited angle of view to be transmitted to the remote instruction apparatus 1. That is, the data amount reduction unit 36 may reduce the data amount of the sensor information by narrowing the angle of view of the sensor of which the type is determined by the sensor type determination unit 35.

As described above, among the sensor information detected by the sensor 22a of which the type is determined by the sensor type determination unit 35, the data amount reduction unit 36 limits the angle of view of the sensor information to be transmitted to the remote instruction apparatus 1 such that the information on the place required to be checked by the remote commander R is included for issuing the remote instruction. In this way, the data amount reduction unit 36 reduces the data amount of the sensor information transmitted to the remote instruction apparatus 1.

Second Reduction Method: Reduction Method based on Resolution

As a second reduction method of the data amount, the data amount reduction unit 36 reduces the data amount of the sensor information by adjusting a resolution of the sensor information detected by the sensor 22a of which the type is determined by the sensor type determination unit 35.

Here, the data amount reduction unit 36 can reduce the data amount by, for example, reducing the size (reducing the resolution) of an image (sensor information) captured by the camera as a method of adjusting the resolution of the sensor information. For example, in some cases, the remote commander R may be able to recognize the external situation of the remote autonomous driving vehicle 2 by the captured image of low resolution without using the captured image of high resolution. Therefore, the data amount reduction unit 36 can reduce the size of the captured image within a range in which the remote commander R can recognize the external situation, for example.

In addition, for example, the data amount reduction unit 36 can reduce the data amount by changing the storage format of the image (sensor information) captured by the camera as a method of adjusting the resolution of the sensor information. In this case, the data amount reduction unit 36 changes the storage format of the captured image so that the data amount is compressed. For example, if the storage format of the captured image is the BMP format, the data amount reduction unit 36 can change the storage format to the JPEG format. Here also, the data amount reduction unit 36 can change the storage format of the captured image (compress the data amount of the image information) within a range in which the remote commander R can recognize the external situation.

Third Reduction Method: Reduction Method based on Frame Rate

As a third reduction method of the data amount, from the sensor information detected by the sensor 22a of which the type is determined by the sensor type determination unit 35, the data amount reduction unit 36 reduces the data amount of the sensor information by excluding a part of the sensor information at each time from the transmission target.

Here, for example, a camera has a frame rate (also referred to as a sampling frequency) unique to a sensor. For example, in the image information (sensor information) of a camera with a high frame rate, the motion of an object is expressed smoothly. On the other hand, in an image captured by a camera with a low frame rate, the motion of an object is expressed as a frame advance. For example, in some cases, the remote commander R may be able to recognize the external situation of the remote autonomous driving vehicle 2 using the low frame rate image information without using the high frame rate image information. Therefore, the data amount reduction unit 36 reduces the data amount of the image information by excluding a part of the image captured by the camera at each time from the transmission target in a range in which the remote commander R can recognize the external situation, for example.

For example, the data amount reduction unit 36 extracts every six captured images from the image information by the camera that acquires the captured images at 60 [fps]. In this case, the data amount reduction unit 36 can reduce the data amount of the image information by the camera to a data amount equivalent to the image information captured at 10 [fps].

The data amount reduction unit 36 may use the above-described various methods for reducing the data amount independently, or may use a combination of two or more methods. The data amount reduction unit 36 may use a reduction method other than those described above.

In addition, the data amount threshold value, which is a criterion for determining whether or not to perform the data amount reduction, may be variable. For example, the data amount reduction unit 36 may change the data amount threshold value according to the communication state with the remote instruction apparatus 1. In this case, for example, the data amount reduction unit 36 may decrease the data amount threshold value when the communication state is poor, and may increase the data amount threshold value when the communication state is good. In this way, it becomes easier for the data amount reduction unit 36 to perform the data reduction when the communication state is poor. The data amount reduction unit 36 can change the data amount threshold value according to various states or conditions other than the communication state.

Furthermore, the data amount reduction unit 36 may increase the data reduction amount as the data amount of the sensor information detected by the sensor 22a increases. In this case, for example, the data amount reduction unit 36 may set a plurality of data amount threshold values. Specifically, for example, as the data amount threshold value, the data amount reduction unit 36 can set a first data amount threshold value and a second data amount threshold value which is larger than the first data amount threshold value. If the data amount of the sensor information detected by the sensor 22a is equal to or larger than the second data amount threshold value, the data amount reduction unit 36 reduces the data amount. When the data amount of sensor information detected by sensor 22a is equal to or larger than the first data amount threshold value and smaller than the second data amount, the data amount reduction unit 36 reduces the data amount to a smaller extent than when the data amount of the sensor information is equal to or larger than the second data amount threshold value. When the data amount of the sensor information detected by the sensor 22a is smaller than the first data amount threshold value, the data amount reduction unit 36 does not reduce the data amount. As described above, the data amount reduction unit 36 may set a plurality of data amount threshold values and reduce the data amount according to the exceeded data amount threshold value.

In addition, the data amount reduction unit 36 may perform the data amount reduction using a combination of varying the data amount threshold value described above and increasing the data reduction amount as the data amount of the sensor information detected by the sensor 22a increases. In this case, the data amount reduction unit 36 may perform the data amount reduction using a combination of varying the data amount threshold value described above and setting a plurality of the data amount threshold values described above. That is, the data amount reduction unit 36 may change the set plurality of data amount threshold values according to the communication state or the like.

If it is determined by the remote instruction determination unit 34 that the remote instruction request is required, the travel situation information transmission unit 37 transmits the travel situation information on the remote autonomous driving vehicle 2 to the remote instruction apparatus 1 (remote instruction server 10). The travel situation information on the remote autonomous driving vehicle 2 includes information for the remote commander R to recognize the situation of the remote autonomous driving vehicle 2.

Specifically, the travel situation information on the remote autonomous driving vehicle 2 includes the detection information by the vehicle-mounted sensor of the remote autonomous driving vehicle 2 and/or the information (for example, an overhead view image of the remote autonomous driving vehicle 2) generated from the detection information by the vehicle-mounted sensor.

The detection information by the vehicle-mounted sensor includes the sensor information detected by the sensor 22a of which the type is determined by the sensor type determination unit 35 among the sensor information detected by the external sensor 22. That is, the travel situation information includes the sensor information detected by the sensor 22a of which the type is determined by the sensor type determination unit 35 among the sensor information detected by the external sensor 22, and does not include the sensor information by other types of sensors. As described above, the travel situation information transmission unit 37 transmits the travel situation information including the sensor information detected by the sensor 22a of which the type is determined by the sensor type determination unit 35, to the remote instruction apparatus 1. If the data amount of the sensor information is reduced by the data amount reduction unit 36, the travel situation information transmission unit 37 transmits the travel situation information including the sensor information in which the data amount is reduced, to the remote instruction apparatus 1.

In addition, the detection information by the vehicle-mounted sensor may include the detection information by the internal sensor 23. The detection information by the internal sensor 23 may include information on the vehicle speed of the remote autonomous driving vehicle 2 detected by the vehicle speed sensor. The detection information by the internal sensor 23 may include information on the yaw rate of the remote autonomous driving vehicle 2 detected by the yaw rate sensor. The detection information by the internal sensor 23 may include information on the steering angle of the remote autonomous driving vehicle 2. The travel situation information may include information on the travel state of the remote autonomous driving vehicle 2 recognized by the travel state recognition unit 33 based on the detection information by the internal sensor 23.

Furthermore, the travel situation information on the remote autonomous driving vehicle 2 may include the position information on the remote autonomous driving vehicle 2. The travel situation information on the remote autonomous driving vehicle 2 may include information on the occupants (presence or absence of the occupants or the number of occupants). The travel situation information on the remote autonomous driving vehicle 2 may include information on the trajectory according to the remote instruction selectable by the remote commander R. The trajectory will be described later.

The trajectory generation unit 38 generates a trajectory used for the autonomous driving of the remote autonomous driving vehicle 2. The trajectory generation unit 38 generates the trajectory of the autonomous driving based on the target route set in advance, the map information, the position information on the remote autonomous driving vehicle 2, the external environment of the remote autonomous driving vehicle 2, and the travel state of the remote autonomous driving vehicle 2. The trajectory corresponds to a travel plan of the autonomous driving.

The trajectory includes a path where the vehicle travels by the autonomous driving and a vehicle speed plan in the autonomous driving. The path is a locus that the vehicle in the autonomous driving will travel on the target route. For example, data (steering angle profile) on the change of the steering angle of the remote autonomous driving vehicle 2 according to the position on the target route can be the path. The position on the target route is, for example, a set longitudinal position set in each predetermined interval (for example, 1 m) in the traveling direction of the target route. The steering angle profile is data in which a target steering angle is associated with each set longitudinal position.

The target route is set based on, for example, the destination, the map information, and the position information on the remote autonomous driving vehicle 2. The target route may be set in consideration of traffic information such as a traffic congestion. The target route may be set by a well-known navigation system. The destination may be set by the occupant of the remote autonomous driving vehicle 2 and may be proposed automatically by the autonomous driving ECU 20 or the navigation system.

The trajectory generation unit 38 generates the path on which the remote autonomous driving vehicle 2 will travel, based on, for example, the target route, the map information, the external environment of the remote autonomous driving vehicle 2, and the travel state of the remote autonomous driving vehicle 2. The trajectory generation unit 38 generates the path such that, for example, the remote autonomous driving vehicle 2 passes through the center of the lane included in the target route (the center in the lane width direction).

The vehicle speed plan is data in which a target vehicle speed is associated with each set longitudinal position, for example. The set longitudinal position may be set based on the traveling time of the remote autonomous driving vehicle 2 instead of the distance. The set longitudinal position may be set as an arrival position of the vehicle after 1 second or an arrival position of the vehicle after 2 seconds. In this case, the vehicle speed plan can also be expressed as data according to the travel time.

The trajectory generation unit 38 generates the vehicle speed plan based on traffic regulation information such as a legal speed included in the path and map information, for example. Instead of the legal speed, a legal speed set in advance for the position or the section on the map may be used. The trajectory generation unit 38 generates an autonomous driving trajectory from the path and the vehicle speed profile. The method of generating the trajectory by the trajectory generation unit 38 is not limited to the above-described content, and a well-known method regarding the autonomous driving can be adopted. The same applies to the contents of trajectory.

If the remote instruction is requested to the remote instruction server 10 by the remote instruction determination unit 34, or if the remote autonomous driving vehicle 2 approaches the intersection or the like which is the target of the remote instruction, the trajectory generation unit 38 generates the trajectory corresponding to the remote instruction in advance. The content of the remote instruction is determined in advance according to the situation of the remote autonomous driving vehicle 2. For example, the content of the remote instruction at the time of turning right at the intersection includes a remote instruction to progress (start to turn right) and a remote instruction to stop (determination pending). The content of the remote instruction at the time of turning right at the intersection may include a remote instruction to go straight without performing the right turn (remote instruction to change the route), or may include the remote instruction to perform the emergency evacuation.

The trajectory generation unit 38 generates a trajectory for the remote autonomous driving vehicle 2 to turn right at the intersection such that, for example, the remote autonomous driving vehicle 2 responses to the remote instruction to start the right turn in a situation of turning right at the intersection. The trajectory generation unit 38 may update the trajectory according to the change in the external environment until the remote instruction is received. In addition, if the remote instruction to switch to go straight at the intersection from the right turn at the intersection is present, the trajectory generation unit 38 may generate the trajectory to go straight through the intersection in advance.

If the remote instruction for the emergency evacuation is present, the trajectory generation unit 38 may generate the trajectory for the emergency evacuation in advance. The emergency evacuation trajectory is generated such that the remote autonomous driving vehicle 2 stops at any of the evacuation spaces set on the map in advance. The trajectory generation unit 38 recognizes the presence or absence of an obstacle at each evacuation space based on the external environment, for example, and generates the trajectory for the emergency evacuation such that the vehicle stops at the empty evacuation space. The trajectory generation unit 38 does not necessarily need to generate the trajectory in advance, and may generate the trajectory in response to the remote instruction after receiving the remote instruction.

The autonomous driving control unit 39 performs the autonomous driving of the remote autonomous driving vehicle 2. The autonomous driving control unit 39 performs the autonomous driving of the remote autonomous driving vehicle 2 based on, for example, the external environment of the remote autonomous driving vehicle 2, the travel state of the remote autonomous driving vehicle 2, and the trajectory generated by the trajectory generation unit 38. The autonomous driving control unit 39 performs the autonomous driving of the remote autonomous driving vehicle 2 by transmitting a control signal to the actuator 26.

If the remote instruction is requested to the remote instruction server 10 by the remote instruction determination unit 34, the autonomous driving control unit 39 waits for the reception of the remote instruction from the remote instruction server 10. If the remote instruction is requested after the remote autonomous driving vehicle 2 stops, the autonomous driving control unit 39 maintains the stopped state until the remote instruction is received.

If the occupant having a driver's license is on board and when the remote instruction is not received even after a waiting time set in advance has elapsed, the autonomous driving control unit 39 may require a determination by the occupant or the manual driving. If the remote instruction is not received even after the waiting time has elapsed, and the determination by the occupant or the manual driving is not possible (a case where the occupant is not on board, or the like), the autonomous driving control unit 39 may perform the emergency evacuation autonomously.

### Configuration of Remote Instruction Apparatus

Hereinafter, a configuration of the remote instruction apparatus 1 according to the present embodiment will be described with reference to the drawings. As illustrated in FIG. 1, the remote instruction apparatus 1 includes a remote instruction server 10, and commander interfaces 3.

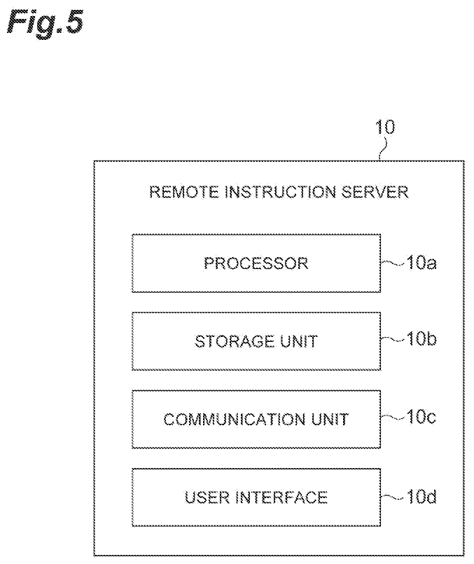

First, a hardware configuration of the remote instruction server 10 will be described. FIG. 5 is a block diagram illustrating an example of a hardware configuration of the remote instruction server 10. As illustrated in FIG. 5, the remote instruction server 10 is configured as a general computer including a processor 10a, a storage unit 10b, a communication unit 10c, and a user interface 10d. The user in this case means a user (administrator or the like) of the remote instruction server 10.

The processor 10a controls the remote instruction server 10 by operating various operating systems. The processor 10a is an arithmetic unit such as a central processing unit (CPU) including a control device, an arithmetic device, a register, and the like. The processor 10a performs overall management of the storage unit 10b, the communication unit 10c, and the user interface 10d. The storage unit 10b is configured to include at least one of a memory and a storage. The memory is a recording medium such as a ROM and a RAM. The storage is a recording medium such as a hard disk drive (HDD).

The communication unit 10c is a communication device for performing communication via the network N. A network device, a network controller, a network card, and the like can be used as the communication unit 10c. The user interface 10d is an input output unit of the remote instruction server 10 to and from the user such as an administrator. The user interface 10d includes output devices such as a display and a speaker, and an input device such as a touch panel. The remote instruction server 10 does not necessarily need to be provided in the facility, and may be mounted on a moving body such as a vehicle.

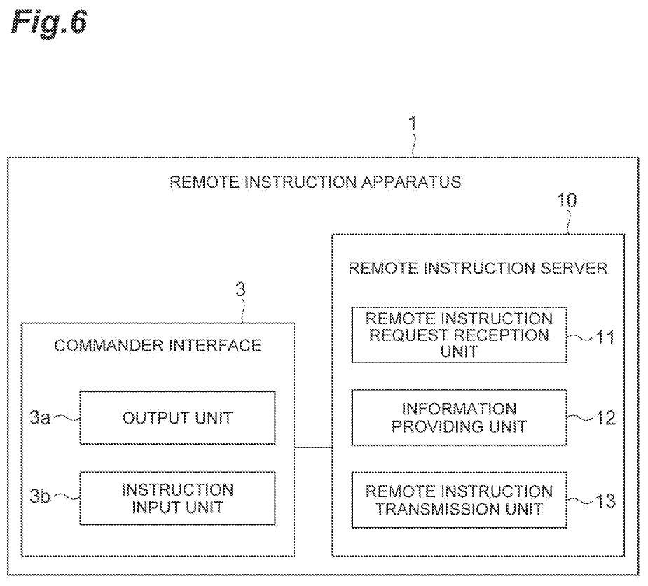

FIG. 6 is a block diagram illustrating an example of the configuration of the remote instruction apparatus 1. As illustrated in

FIG. 6, the commander interface 3 is an input output unit of the remote instruction apparatus 1 to and from the remote commander R. The commander interface 3 includes an output unit 3a and an instruction input unit 3b.

The output unit 3a is a device that outputs information used for the remote instruction of the remote autonomous driving vehicle 2 to the remote commander R. The output unit 3a includes a display that outputs image information and a speaker that outputs sound information.

For example, an image (an image of a scenery ahead) in the front direction of the remote autonomous driving vehicle 2 captured by the camera of the remote autonomous driving vehicle 2 is displayed on the display. The display may have a plurality of display screens, and images of the side and/or rear direction of the remote autonomous driving vehicle 2 may be displayed. The display is not particularly limited as long as the display can provide visual information to the remote commander R. The display may be a wearable device mounted to cover the eyes of the remote commander R.

The speaker is a headset speaker mounted to a head of the remote commander R, for example. For example, the speaker informs the remote commander R of the situation of the remote autonomous driving vehicle 2 (for example, the situation such as a right turn at the intersection) by the voice. The speaker does not necessarily need to be a headset, and may be a stationary type.

The output unit 3a may provide the information to the remote commander R by vibration. The output unit 3a may include, for example, a vibration actuator provided on a seat of the remote commander R. The output unit 3a may alert the remote commander R about the approach of another vehicle to the remote autonomous driving vehicle 2 by the vibration. The output unit 3a may include the vibration actuators on the left and right sides of the seat, and may vibrate the vibration actuators at the positions corresponding to the approaching direction of other vehicles. The output unit 3a may include a wearable vibration actuator that is mounted to a body of the remote commander R. The output unit 3a can provide the information to the remote commander R by vibrating the vibration actuator mounted at each position of the body in accordance with the approaching direction of the other vehicles.

The instruction input unit 3b is a device for inputting the remote instruction by the remote commander R. The instruction input unit 3b includes, for example, an operation lever. In the instruction input unit 3b, for example, a remote instruction for causing the remote autonomous driving vehicle 2 to progress is input by tilting the operation lever toward the depth side in the front-rear direction of the remote commander R, and a remote instruction for decelerating or stopping the remote autonomous driving vehicle 2 is input by tilting the operation lever toward the front side in the front-rear direction of the remote commander R.

The instruction input unit 3b may include a button, and a remote instruction may be input by the remote commander R by tilting the operation lever while pressing the button. The instruction input unit 3b may include a touch panel. The display of the output unit 3a may be commonly used as the touch panel. The instruction input unit 3b may include an operation pedal.

The instruction input unit 3b may have a voice recognition function or a gesture recognition function. The gesture of the remote commander R can be recognized by a camera mounted on the commander interface 3 and/or a radar sensor. In the instruction input unit 3b, the remote instruction may be input by combining two or more of the operation of the operation lever, the operation of the button, the operation of the touch panel, the operation of the operation pedal, the input of the voice, and the gesture.

Next, a functional configuration of the remote instruction server 10 will be described. As illustrated in FIG. 6, the remote instruction server 10 includes a remote instruction request reception unit 11, an information providing unit 12, and a remote instruction transmission unit 13.

The remote instruction request reception unit 11 receives a remote instruction request when the remote autonomous driving vehicle 2 requests the remote instruction server 10 for the remote instruction. In addition, the remote instruction request reception unit 11 acquires the travel situation information on the remote autonomous driving vehicle 2 that has requested for the remote instruction, by the transmission from the remote autonomous driving vehicle 2. The remote instruction request reception unit 11 may acquire the travel situation information on the remote autonomous driving vehicle 2 which does not request for the remote instruction.

The information providing unit 12 provides various types of information to the remote commander R. If the remote instruction request reception unit 11 receives the remote instruction request, the information providing unit 12 requests the responsible remote commander R via the commander interface 3 to input the remote instruction.

In addition, the information providing unit 12 provides information on the remote autonomous driving vehicle 2 to the remote commander R based on the travel situation information on the remote autonomous driving vehicle 2 acquired by the remote instruction request reception unit 11. For example, the information providing unit 12 displays an image of the front direction of the remote autonomous driving vehicle 2 on the display of the output unit 3a of the commander interface 3. The information providing unit 12 may display an image viewed from the vicinity of the driver's seat of the remote autonomous driving vehicle 2 by viewpoint conversion. The information providing unit 12 may display the image of the side direction and the image of the rear direction of the remote autonomous driving vehicle 2. The information providing unit 12 may display a panoramic image that is a composite image of the images in which the surroundings of the remote autonomous driving vehicle 2 are captured, or may display an overhead image generated to look down the remote autonomous driving vehicle 2 by the image composition and the viewpoint conversion. The information providing unit 12 may perform highlight display of an object in the image (for example, marking that surrounds another vehicle or the like with a frame). If a traffic signal is included in the image, the information providing unit 12 may display a result of recognizing the lighting state of the traffic signal on the display.

The information providing unit 12 may display various information on the display, not limited to the camera image captured by the camera of the remote autonomous driving vehicle 2. The information providing unit 12 may display the situation of the remote autonomous driving vehicle 2 which requested for the remote instruction (the situation at the time of the right turn at the intersection, the situation avoiding the obstacle by the offset avoidance, or the like) using texts or icons. The information providing unit 12 may display a type of remote instruction (progressive traveling, waiting, and the like) that can be selected by the remote commander R, on the display. The information providing unit 12 may display the information (a locus on which the remote autonomous driving vehicle 2 performs progressing corresponding to the remote instruction to perform the progressing) relating to the trajectory of the remote autonomous driving vehicle 2 in accordance with the remote instruction, on the display.

The information providing unit 12 may display the information on an object detected by the radar sensor of the remote autonomous driving vehicle 2. The information on the object may be displayed as an icon in the overhead image. When the types of the objects are identified, the icons may be displayed according to the types of the objects. The information providing unit 12 may display the map information on the surroundings of the remote autonomous driving vehicle 2 acquired based on the position information on the remote autonomous driving vehicle 2, on the display. The map information may be included in the remote instruction server 10 or may be acquired from another server or the like. The map information on the surroundings of the remote autonomous driving vehicle 2 may be acquired from the remote autonomous driving vehicle 2.

The information providing unit 12 may display the road traffic information acquired based on the position information on the remote autonomous driving vehicle 2 on the display. The road traffic information includes at least one of information on a traffic congestion occurring section or information on a construction section, information on an accident position, and the like. The road traffic information can be acquired from, for example, a traffic information center.

The information providing unit 12 may display information on the vehicle speed of the remote autonomous driving vehicle 2 on the display, and may display information on the steering angle of the remote autonomous driving vehicle 2 on the display. The information providing unit 12 may display information on a slope of the road where the remote autonomous driving vehicle 2 is positioned, on the display.

If the remote autonomous driving vehicle 2 has a vehicle interior camera, the information providing unit 12 may display an image of the vehicle interior of the remote autonomous driving vehicle 2 as necessary. The information providing unit 12 may display an occupant's boarding situation and/or luggage loading situation in the remote autonomous driving vehicle 2, on a display.

The information providing unit 12 provides the sound information to the remote commander R through the speaker of the output unit 3a of the commander interface 3. The information providing unit 12 may output the situation (at the time of right turn at the intersection, at the time of avoiding the obstacle by the offset avoidance, or the like) of the remote autonomous driving vehicle 2, from the speaker as the voice. The information providing unit 12 may output the approach of another vehicle or the like around the remote autonomous driving vehicle 2, as the sound or the voice from the speaker. The information providing unit 12 may directly output the sound (noise) around the remote autonomous driving vehicle 2, from the speaker. The information providing unit 12 may output an occupant's voice in the vehicle, from the speaker as necessary. In some embodiments, the information may not be provided through the speaker.

In addition, if the output unit 3a includes the vibration actuator, the information providing unit 12 may provide the information to the remote commander R by the vibration. In this case, the information providing unit 12 can provide the information to the remote commander R (alert) by, for example, vibrating the vibration actuator at a position corresponding to the direction to which attention should be paid, such as the approaching direction of another vehicle to the remote autonomous driving vehicle 2 or the direction where a pedestrian is present.

If the remote commander R inputs the remote instruction to the instruction input unit 3b of the commander interface 3, the remote instruction transmission unit 13 transmits the input remote instruction to the remote autonomous driving vehicle 2. If the remote instruction input by the remote commander R is transmitted to the remote autonomous driving vehicle 2, the information providing unit 12 may continuously transmit the information on the remote autonomous driving vehicle 2 to the remote commander R, or may switch the information to information on another remote autonomous driving vehicle 2 that requests for the remote instruction.

### Flow of Processing for Transmission of Travel Situation Information

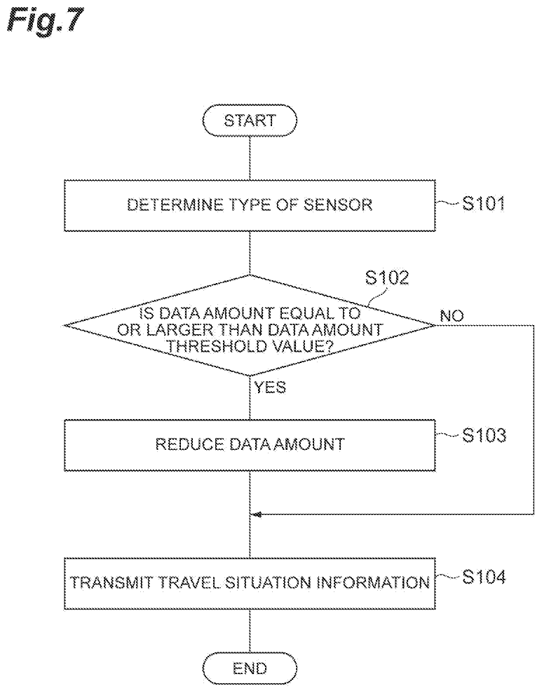

Next, a flow of processing for the autonomous driving ECU 20 to generate and transmit the travel situation information when it is determined by the remote instruction determination unit 34 that the remote instruction request is required, will be described with reference to a flowchart in FIG. 7. The processing illustrated in FIG. 7 is started when the remote instruction determination unit 34 determines that the remote instruction request is required.

As illustrated in FIG. 7, when the remote instruction determination unit 34 determines that the remote instruction request is required, the sensor type determination unit 35 determines the type of the sensor 22a that transmits the sensor information to the remote instruction apparatus 1, based on the external environment or the map information on the remote autonomous driving vehicle 2 (S101). The data amount reduction unit 36 determines whether or not the data amount of the sensor information detected by the sensor 22a of which the type is determined by the sensor type determination unit 35 is equal to or larger than the data amount threshold value (S102).

If the data amount is equal to or larger than the data amount threshold value (YES in S102), the data amount reduction unit 36 reduces the data amount of the sensor information detected by the sensor 22a of which the type is determined by the sensor type determination unit 35 (S103). Then, the travel situation information transmission unit 37 generates the travel situation information including the sensor information in which the data amount is reduced by the data amount reduction unit 36, and transmits the travel situation information to the remote instruction apparatus 1 (S104).

On the other hand, if the data amount is not equal to or larger than the data amount threshold value (NO in S102), the data amount reduction unit 36 does not reduce the data amount. Then, the travel situation information transmission unit 37 generates the travel situation information including the sensor information detected by the sensor 22a of which the type is determined by the sensor type determination unit 35, and transmits the travel situation information to the remote instruction apparatus 1 (S104).

As described above, in the vehicle remote instruction system 100, the type of the sensor 22a that transmits the sensor information to the remote instruction apparatus 1 is determined based on the external environment or the map information, and the sensor information detected by the determined type sensor 22a is transmitted. That is, in the vehicle remote instruction system 100, the sensor information by the sensor 22a of which the type is determined based on the external environment or the map information is transmitted, and the sensor information by the sensor of other types is not transmitted. In addition, in the vehicle remote instruction system 100, when determining the type of the sensor 22a, the determination is performed based on the external environment or the map information. In this way, the remote commander R can appropriately issue the remote instruction to the remote autonomous driving vehicle 2 based on the sensor information by the sensor 22a of which the type is determined based on the external environment or the map information. As described above, in the vehicle remote instruction system 100, it is possible to reduce the data amount of the sensor information transmitted from the remote autonomous driving vehicle 2 to the remote instruction apparatus 1 while providing the remote commander R with the sensor information by the appropriate type of sensor for performing the determination of the remote instruction.

The remote autonomous driving vehicle 2 includes the data amount reduction unit 36 that reduces the data amount when the data amount of the sensor information detected by the sensor 22a of which the type is determined by the sensor type determination unit 35 is equal to or larger than the data amount threshold value. In this case, if the data amount of the detected sensor information is equal to or larger than the data amount threshold value, the remote autonomous driving vehicle 2 can transmit the sensor information with reducing the data amount. In this way, the remote autonomous driving vehicle 2 can further reduce the data amount to be transmitted.

The data amount reduction unit 36 reduces the data amount of the sensor information by limiting the angle of view of the sensor information transmitted to the remote instruction apparatus 1 based on the map information. In this case, the remote autonomous driving vehicle 2 can further reduce the data amount of the sensor information transmitted to the remote instruction apparatus 1 while enabling the remote commander R to issue an appropriate remote instruction based on the sensor information having a limited angle of view based on the map information.

As described above, the embodiment of the present disclosure has been described, the present disclosure is not limited to the embodiment. For example, in some embodiments, the data amount reduction unit 36 may not reduce the data amount. The sensor information detected by the sensor 22a determined by the sensor type determination unit 35 may be transmitted to the remote instruction apparatus 1 without reducing the data amount. In addition, even if the data amount of the sensor information detected by the sensor 22a of which the type is determined by the sensor type determination unit 35 is less than the data amount threshold value, the data amount reduction unit 36 may edit the sensor information detected by the sensor 22a. Then, the edited sensor information may be transmitted to the remote instruction apparatus 1.

The remote instruction apparatus 1 may be mounted on a remote autonomous driving vehicle 2. In this case, the remote commander R is also in the remote autonomous driving vehicle 2. The remote instruction server 10 may be a cloud server configured with ECUs of a plurality of remote autonomous driving vehicles 2.

What is claimed is:

1. A remote autonomous driving vehicle that includes a plurality of sensors for detecting surroundings of a vehicle, transmits sensor information detected by one of the plurality of sensors to a remote instruction apparatus, and travels based on a remote instruction issued from a remote commander through the remote instruction apparatus, the vehicle comprising:
a sensor type determination unit configured to determine a type of the sensor that transmits the sensor information to the remote instruction apparatus based on an external environment and map information; and
a sensor information transmission unit configured to transmit the sensor information detected by the sensor of which the type is determined by the sensor type determination unit to the remote instruction apparatus.

2. The remote autonomous driving vehicle according to claim 1, further comprising;
a data amount reduction unit configured to reduce a data amount of the sensor information detected by the sensor of which the type is determined by the sensor type determination unit,
wherein the data amount reduction unit is configured to reduce the data amount if the data amount of the sensor information detected by the sensor of which the type is determined by the sensor type determination unit is equal to or larger than a data amount threshold value determined in advance, and
wherein the sensor information transmission unit is configured to transmit the sensor information in which the data amount is reduced by the data amount reduction unit, to the remote instruction apparatus.

3. The remote autonomous driving vehicle according to claim 2,
wherein the data amount reduction unit is configured to reduce the data amount of the sensor information by limiting an angle of view to be transmitted to the remote instruction apparatus in the sensor information detected by the sensor of which the type is determined by the sensor type determination unit based on the map information.

4. A vehicle remote instruction system comprising:
the remote autonomous driving vehicle according to claim 1; and
a remote instruction apparatus in which a remote commander issues a remote instruction relating to travel of the remote autonomous driving vehicle.
